(19) United States
(12) Patent Application Publication
(10) Pub. No.: US 2002/0009976 A1
(43) Pub. Date: Jan. 24, 2002

(54) Radiation protection device for cellular telephones

(76) Inventor: Taymor S. Rashidi, Los Angeles, CA (US)

Correspondence Address: ALLAN M. SHAPIRO, 18401 Burbank Boulevard, Suite 202, Tarzana, CA, 91356-2824, US

(21) Appl. No.: 09/740,379

(22) Filed: Dec. 19, 2000

Related U.S. Application Data
(60) Provisional application No. 60/175,149, filed on Jan. 7, 2000.

(51) Int. Cl. H04B 1/38

(52) U.S. Cl. 455/90; 455/550; 455/575

(57) ABSTRACT

The radiation-protection device for cellular telephones places a radiation-resistant protective panel between the cellular telephone and the head of the person using the telephone. This protective panel may be mounted directly on the telephone. It may be mounted directly upon the case in which the telephone is housed or may be a portion of the case which is swung up into position between the telephone antenna and the user's head when the telephone is in use.

### CROSS REFERENCE

This application relies upon U.S. Provisional Application Ser. No. 60/175,149, filed Jan. 7, 2000, for priority.

### FIELD OF THE INVENTION

This invention relates to positioning radio frequency radiation-resistant material between the human head and the source of such radiation to protect the head.

### BACKGROUND

Many forms of communications equipment contain components which transmit and receive radio frequency energy as electromagnetic radiation. Cellular telephones are an example of communication devices which are transceivers which both transmit and receive signals as electromagnetic energy in the radio frequency bands. Cellular telephones operate in the ultra-high frequency bands between 700 Megahertz and 1 Gigahertz. The incoming radio frequency energy from a central station or a cell site retransmitter are at a lower energy level than the outgoing signal back to the base station or cell site, purely as a matter of distance. The pocket or hand-held telephones have a maximum output power of 0.7 watts. The cellular telephone which is carried like a briefcase or is permanently mounted in an automobile has an output power of up to 7 watts of radio frequency energy.

There have been concerns about health problems linked to cellular telephones. These concerns are related to the studies indicating that there may be physiological damage caused by that much radio frequency energy transmission that close to the human head. This is a question of the safety of the human being with respect to the exposure he receives from this amount of radio frequency energy that close to the user's head. While there does not appear to be a definitive study which shows that such radio frequency energy causes physiological damage, it is well to protect the head from such energy as a worthy precaution.

### SUMMARY OF THE INVENTION

In order to aid in the understanding of this invention, it can be stated in essentially summary form that it is directed to placing a radiation-resistant device between a cellular telephone and the user's head. The radiation-resistant device can be mounted on the telephone case, can form a part of the telephone case or may be mounted on the telephone itself. The radiation-resistant device is preferably a layer of material which reflects a substantial amount of the cellular telephone transmitter energy away from the user's head.

It is thus a purpose and advantage of this invention to provide a radiation shield which is positioned between the cellular telephone antenna and cellular telephone radio frequency energy-generating parts and the user's head to attenuate the radio frequency energy incident to the user's head.

It is another purpose and advantage of this invention to provide a radiation-resistant structure which can be mounted directly on the telephone so that it is positioned between the antenna of the telephone and the user's head.

It is a further purpose and advantage of this invention to provide a radiation-protective device which includes forming a cellular telephone case of radiation-resistant material so that a substantial part of the body of the telephone is encased in the radiation-resistant material.

It is another purpose and advantage of this invention to provide an enhanced comfort for the user of the telephone so he is less concerned about radio frequency energy-caused physiological deterioration or other adverse effects.

It is a further purpose and advantage of this invention to provide a radiation protective device which is configured and mounted so that it can be easily used and is structured so that it is inexpensive so that it is widely used to enhance protection from radio frequency energy-caused deterioration.

The features of this invention which are believed to be novel are set forth with particularity in this specification. The present invention, both as to its organization and manner of operation, together with further objects and advantages thereof, may be best understood by reference to the following description, taken in conjunction with the accompanying drawings.

### BRIEF DESCRIPTION OF THE DRAWINGS

FIG. 1 is a perspective view of a hand-held cellular telephone having the first preferred embodiment of the radiation protective device of this invention thereon in the form of a telephone case and antenna shield, seen from the active front side of the telephone.

FIG. 2 is a similar view, seen from the back of the telephone.

FIG. 3 is a similar view, showing the case closed.

FIG. 4 is an elevational view with parts broken away of the radiation protective device in accordance with this invention, showing the antenna flap extended.

FIG. 5 is an enlarged sectional view, taken generally along the line 5-5 of FIG. 4, showing the telephone and the radiation protective device adjacent a human head.

FIG. 6 is a plan view of a spring which is alternative to the spring shown in FIG. 4.

FIG. 7 is a front view of a different cellular telephone, showing the second preferred embodiment of the radiation protective device in accordance with this invention configured therefor.

FIG. 8A is a section taken generally along the line 8A-8A of FIG. 7.

FIG. 8B is a cross-section of an alternative material as seen along the line 8A-8A of FIG. 7.

FIG. 9 is a perspective view of a third preferred embodiment of the radiation protective device in accordance with this invention shown mounted on a hand-held cellular telephone.

FIG. 10 is an enlarged section taken generally along line 10-10 of FIG. 9.

### DESCRIPTION OF THE PREFERRED EMBODIMENTS

FIGS. 1, 2, 3 and 5 show a conventional cellular telephone (sometimes referred to herein as “cell phone”). The cellular telephone 10 has a housing 12 which contains most of the telephone equipment. An antenna 14 extends upwardly out of the housing. The housing contains or has attached thereto a battery for powering the system. The housing contains radio frequency transmitting equipment and radio frequency receiving equipment, usually in two different RF bands so that two-way communication can be achieved. The cell phone 10 has a front face 16 which may include various touch buttons for operating and controlling the cell phone. It may have a display 18 for displaying information related to the cell phone. The display 18 is usually a liquid crystal device. The front face of the phone has a speaker behind speaker holes 20 in telephone case 22. Further, it has a microphone behind microphone holes 24.

When active, the front face of the telephone is held to the side of the face with the speaker holes adjacent the ear and the microphone adjacent the mouth for two-way communication. Cell phones currently operate at frequencies between 700 Megahertz and 1 Gigahertz. The power output of such telephones has been limited to 0.7 Watts and, at the time the standard was adopted, it was thought that this level of power even that close to the human head would not be physiologically detrimental. There is radio frequency power-generating equipment within the housing which generates this RF output power. The housing 12 itself serves as a radiation shield for a portion of that radiation, but the antenna 14 is exposed for radiation in all directions. It is the antenna 14 that radiates the major part of the energy and, accordingly, is of the most concern.

In order to reduce the amount of radiant energy directed toward the person using the telephone, the case 22 is provided. Case 22 is constructed of substantially flexible material in one or more layers. At least one layer of the case material is resistant to electromagnetic radiation in the cellular telephone frequency bands. An electrically conductive mesh such as knitted or woven fabric made of strands of thin wire is suitable. Such a mesh may be incorporated into a synthetic polymer composition material sheet. The strands from which the woven or knitted fabric are made could be synthetic or natural fibers which are coated with a metallic layer, such as aluminum, copper or silver. Instead of using conductive strands, a polymer layer can be loaded with metallic flakes. In such a case, sufficient loading of metallic flakes into the synthetic polymer composition material is necessary to obtain substantial conductivity between the flakes to provide radiation attenuation. When formed in such a manner, the synthetic polymer composition sheet may be colored and textured in a manner that it can serve also as the exterior surface in a decorative manner. In such a case, only one layer of case material may be necessary. In other situations, a separate structural layer is created separately from the decorative and physically protective sheet layer and then the layers will be laminated together.

As seen in FIGS. 1, 2, 3, 4 and 5, the case 22 has a front 26 which covers the front of the telephone and may have openings therethrough for audio, visual or tactile access to the cellular telephone 10 itself. The case also has a back 28 and an edge 30 which extends around both edges and the bottom of the cell phone. The edge 30 is attached to the front and back to form a pocket into which the cell phone is inserted. While the back 28 need not be formed of radiation-resistant material, it is useful as physical protection for the cellular telephone. It is thus convenient to make all parts of the same material.

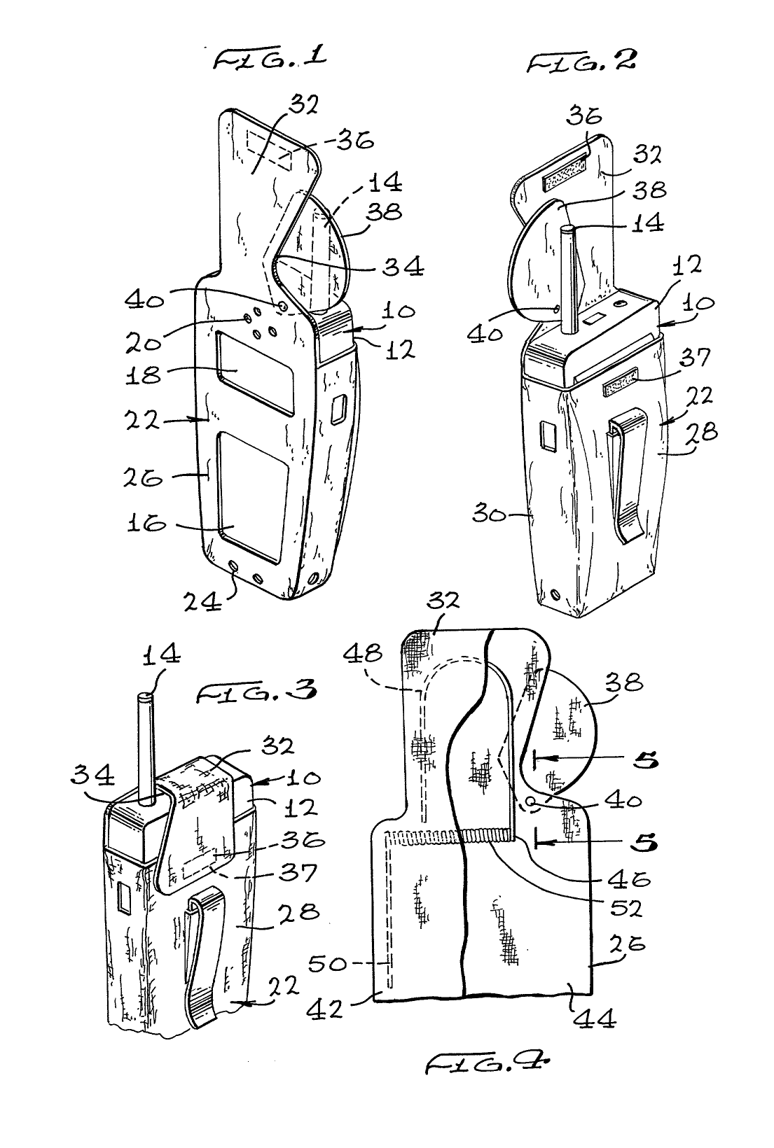

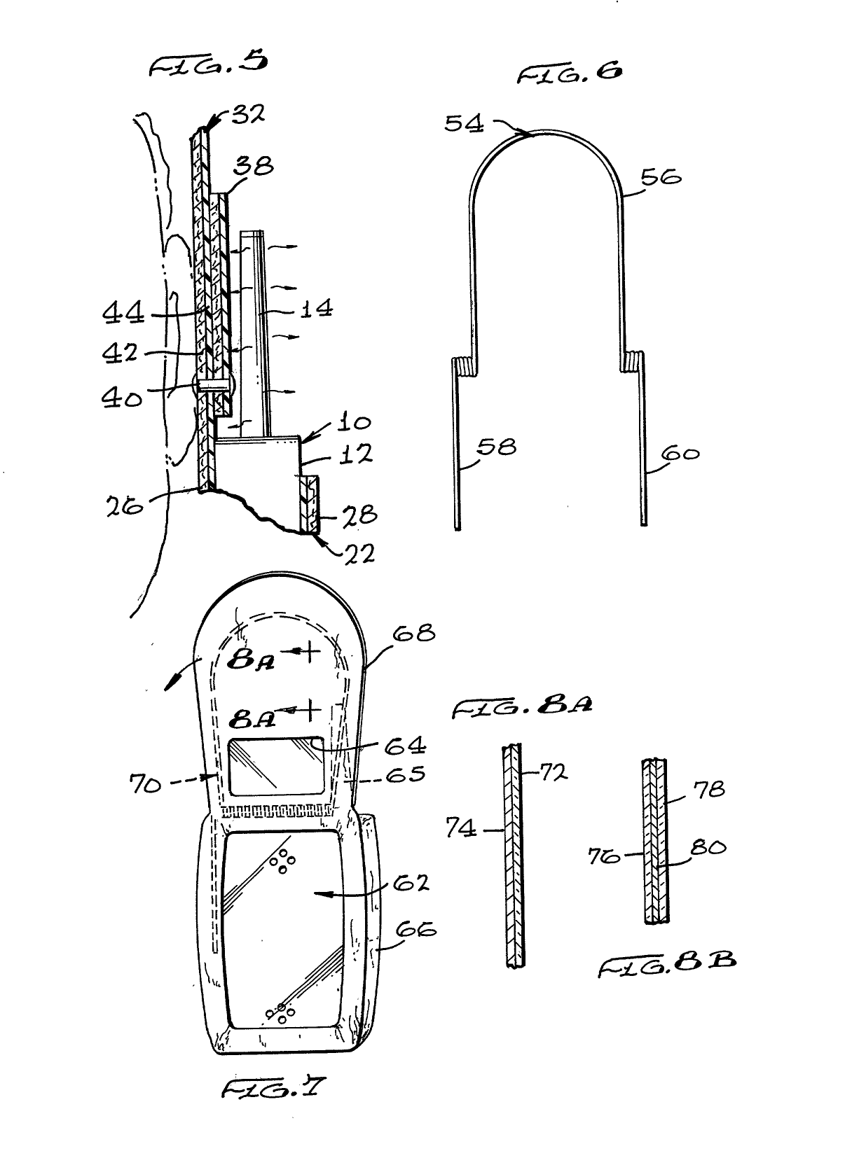

The top of the case front has protective panel 32 contiguously formed therewith. When in the open position shown in FIGS. 1, 2, 4 and 5, the protective panel extends upward above the top of antenna 14. Protective panel 32 has a notch 34 therein which permits the panel to be folded down around the antenna 14 and over the top of the case, to the closed position. Hook and loop fasteners 36 and 37, see FIG. 2, releasably hold the protective panel down in the position of FIG. 3. When raised, the protective panel lies generally along the plane of the front of case 26, with which it is contiguous. Fan-shaped notch-covering panel 38 is pivoted on the panel 32 on pivot 40. The pivot point is preferably located so that, when the protective panel 32 is raised, the pivoted notch covering panel 38 falls into the notch covering position of FIGS. 1, 2 and 4. When the cellular telephone is not in use, the notch-covering panel is pivoted back underneath protective panel 32 to expose the notch to permit the panel 32 to be folded down around the antenna 14. In FIGS. 4 and 5, the case front 26 is shown as having an outer structural layer 42 and an inner radiation-resistant layer 44. It is seen in FIG. 5 that the notch-covering panel 38 is formed of the same layers. The outer layer is the structural and decorative layer which provides physical protection for the cellular telephone and the inner layer is the radiation-resistant layer of the nature described above. When two-layer structures are employed, as thus described, a spring 46 is employed to resiliently hold the protective panel 32 in the upright position shown in FIGS. 1, 2, 4 and 5. The spring has an upper loop 48 embedded in the protective panel 32 and a lower leg 50 embedded in the case front 26. The spring is embedded between the two layers. If only a single layer of combined structurally-protective and radiation-resistant material is used, the spring may be secured to the inside face. Upper loop 48 and lower leg 50 of the spring 46 are joined by a spring coil 52 which permits the spring and protective panel 32 to flex as it is moved from the position in FIG. 2 to the position in FIG. 3. The spring is made of very fine wire which permits the proper flexure, because very little strength is required to hold the protective panel 32 in the upper, protected position in FIGS. 1, 2, 4 and 5.

FIG. 6 shows spring 54 which can be used alternatively to the spring 48. The spring 54 has an upper loop 56 and two lower legs 58 and 60. The lower legs extend down into the case front 26 while the upper loop 56 extends up into the protective panel 32. The spring coils illustrated between the loop and the legs lie at the top edge of the cellular telephone 10. The spring 54 also resiliently holds the protective panel 32 in the upper, protective position and permits the protective panel to fold over the top of the cellular telephone in the same manner as shown in FIG. 3.

The cellular telephone 62 shown in FIG. 7 is of a different configuration. It has a cover which hinges up from the main body of the telephone, when the telephone is in use. The cover may carry a display or other structure necessary for telephone operation. The telephone 62 has an antenna 65, seen only in dashed lines extending upward from the main body of the cellular telephone, in FIG. 7. For a cellular telephone of this configuration, the protective case 66 covers the face of the telephone. The case 66 has openings through which the telephone can be visually, tactually and audibly accessed. The protective panel 68 is integrally formed with the front of the protective case. It folds upward into the active position between the head of the user and the antenna, shown in FIG. 7, when the telephone is in use. It folds down to cover the front face of the telephone when the telephone is not in use. Spring 70 is incorporated into the protective panel 68 to urge the protective panel upward when the cellular telephone is in use. The spring 70 is of the same general nature as the springs 46 and 54.

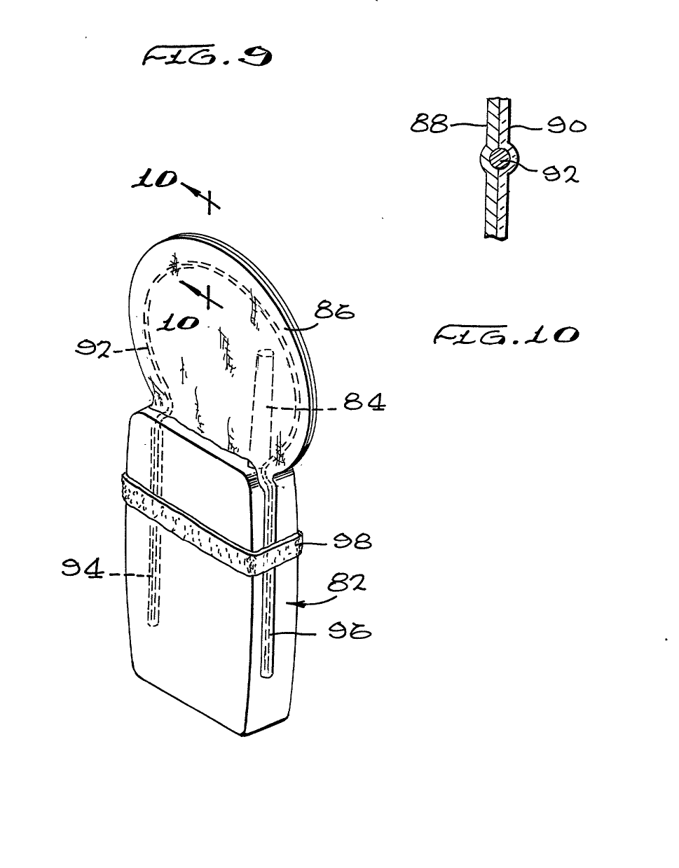

The protective panel 68 is formed of a cover layer 72 and a protective layer 74 shown in FIG. 8A. The cover layer is decorative and sturdy enough to physically protect the telephone. The protective layer is radiation-resistant in the cellular telephone utilized electromagnetic band described above. The protective layer is also described above. The layers are laminated together and used to form the protective case 66 and protective panel 68. The fact that the protective panel swings down in front of the main body of the telephone into the closed, inactive position precludes the need for a notch to accommodate the antenna 65. FIG. 8B shows a layer of the material for the case wherein the inner layer 76 and the outer layer 78 are laminated upon radiation-resistant material 80. This multiple thickness material is used as the material of the protective panel 68 because both sides of the panel are visible when the protective panel is in its raised, protective position.

It is not necessary to use a case surrounding the cellular telephone to provide support for the protective panel. FIG. 9 shows a cellular telephone 82 which has an antenna 84, shown in dashed lines. In this case, protective panel 86 is configured to rest on the top of the body of the telephone so that it is positioned between the antenna 86 and the head of the user, when the telephone is in use. The protective panel 86 is preferably formed of two layers 88 and 90 which are laminated together, as seen in FIG. 10. Both of these layers may be of material which is resistant to radiation in the relevant radio frequency bands. On the other hand, the side toward the user's head may be suitable for physical contact while the side toward the antenna is radiation-resistant. The protective panel 86 is held in place by means of a wire loop 92 which is laminated between the layers. The legs 94 and 96 extend down from the principal portion of the protective panel, along the edges of the cellular telephone. They are held in place by means of an elastomeric band 98 which clamps the legs against the side of the telephone. Thus, the protective panel is positioned between the user's head and the antenna while the telephone is in use. In the event the user keeps the cell phone in a conventional decorative and/or protective leather case, the legs 94 and 96 may be inserted into the leather case and, thus, the elastomeric band may be eliminated.

The radiation-protective panel works by reflecting radio frequency energy radiated from the antenna. This energy reflects at both interfaces of the protective layer. Up to 90 decibels of the radio frequency energy is reflected or absorbed. This means a reduction in transmitted radio frequency energy in the order of 10⁻⁹. In addition to significantly reducing the transmitted amount of radio frequency energy which may cause physiological damage, the radiation resistant-protective panel also reduces the amount of energy which may be delivered to a hearing aid worn by the telephone user. This reduces any spurious signals or coupling with respect to the electronic hearing aid.

This invention has been described in its presently contemplated best modes and embodiments and it is clear that it is susceptible to numerous modifications, modes and embodiments within the ability of those skilled in the art and without the exercise of the inventive faculty. Accordingly, the scope of this invention is defined by the scope of the following claims.

What is claimed is:

1. An RF radiation protection device for cellular telephones comprising:
an RF radiation attenuating panel;
mounting structure on said RF radiation attenuating panel for mounting said RF radiation attenuating panel on a cellular telephone for positioning said panel on the telephone between the telephone antenna and the user's head while the cellular telephone is in use to reduce incident RF radiation to the user's head.

2. The RF radiation protection device of claim 1 wherein there is at least one leg mounted on said panel, said leg being for extending down alongside the telephone for holding said panel adjacent the antenna of the telephone and there is a resilient band for engaging around said leg and around the telephone to hold said leg against the telephone and hold said panel adjacent the antenna of the telephone.

3. The RF radiation protection device of claim 2 wherein there are two said legs connected to said panel, said two legs being configured for engaging on the telephone in different places and said resilient band engages around both said legs and the telephone.

4. The RF radiation protection device of claim 3 wherein there is a spring loop embedded in said panel and said spring loop has legs extending into said legs of said panel so as to enhance the stiffness of said panel and retain said panel in position between the antenna of the telephone and the user's head.

5. The RF radiation protection device of claim 4 wherein said stiffener is a metallic wire.

6. The RF radiation protection device of claim 1 wherein there is a telephone case for engaging a substantial portion of the body of the telephone and said panel is mounted on said case.

7. The RF radiation protection device of claim 6 wherein said case has a front face and there are openings in said front face, said openings being configured and spaced to permit access to the active face of the cellular telephone and said protective panel folds down over said front face of said case when it is in inactive position and extends upward adjacent the telephone antenna when said panel is in protective position.

8. An RF radiation protection device for a cellular telephone having a front face and having an antenna, comprising:
a cellular telephone case, said case being sized and configured to engage around and substantially embrace a cellular telephone, said case having a front for engaging over the front of the cellular telephone, said case front having openings therein for visual, audible and tactile access to the front of the cellular telephone;
a protective panel attached to said case, said protective panel being at least partially formed of radio frequency energy attenuating material, said protective panel being so attached to said case and positioned that it is between the telephone antenna and the user's head when the telephone is in use.

9. The RF radiation protection device of claim 8 wherein said protective panel is contiguous with said front of said case.

10. The RF radiation protection device of claim 9 wherein said protective panel is configured to fold down over the top of the telephone when the cellular telephone is not in use.

11. The RF radiation protection device of claim 10 wherein said protective device has an attachment device thereon so that it is releasably held down over the top of the telephone when not in use and can be released to be positioned in protective position when in use.

12. The RF radiation protection device of claim 11 wherein said panel has a notch therein so that said notch extends around the telephone antenna when the protective panel is in inactive position.

13. The RF radiation protection device of claim 12 wherein there is a notch-covering panel mounted on said protective panel, said notch-covering panel being made of RF energy-attenuating material and being positionable to extend substantially across said notch when said panel is in active position and is positionable away from said notch when said panel is in inactive position.

14. The RF radiation protection device of claim 8 wherein said panel and said case have detachable fastening structure so that said panel can be folded down over the top of the cellular telephone and detachably attached to said case to substantially cover the top of the telephone when the telephone is not in use.

15. The RF radiation protection device of claim 14 wherein said case is also made of RF energy-attenuating material.

16. The RF radiation protection device of claim 8 wherein said case is also made of RF energy-attenuating material.

17. An RF radiation protection device for cellular telephones having a front face and having an antenna comprising:
a case made of RF energy-attenuating material, said case having a case front for substantially covering said front face of the cellular telephone, said case front being configured for visual, tactile and audio access to the front of the cellular telephone, said case substantially embracing the cellular telephone, said case having a protective panel thereon, said protective panel being mounted on said case so that said protective panel is positioned between the antenna and the user's head when the telephone is in use.

18. The RF radiation protection device for cellular telephones of claim 17 wherein said panel is contiguous with the front of said case.

19. The RF radiation protection device for cellular telephones of claim 18 wherein said protective panel is configured to fold down over the top of the cellular telephone and there is releasable attachment structure between said protective panel and said case to releasably secure said protective panel down over the top of the case and releasably attach to said case when the telephone is not in use.

20. The RF radiation protection device for cellular telephones of claim 19 wherein said protective panel has a notch therein so that said notch in said protective panel engages around the antenna of the cellular telephone when the protective panel is in the inactive position and there is a notch-covering panel formed at least partially of RF energy-attenuating material, said notch-covering panel being mounted on said protective panel so that it can be moved to cover said notch when said protective panel is in its active position between the antenna and the user's head.
